(19) United States
(12) Patent Application Publication
(10) Pub. No.: US 2022/0158925 A1
(43) Pub. Date: May 19, 2022

(54) METHOD AND APPARATUS FOR DETECTING ABNORMAL BEHAVIOR IN MACHINE-TO-MACHINE SYSTEM

(71) Applicants: HYUNDAI MOTOR COMPANY, Seoul (KR); KIA CORPORATION, Seoul (KR); INDUSTRY ACADEMY COOPERATION FOUNDATION OF SEJONG UNIVERSITY, Seoul (KR)

(72) Inventors: Jae Seung Song, Seoul (KR); Min Byeong Lee, Hwaseong-si (KR)

(21) Appl. No.: 17/526,458

(22) Filed: Nov. 15, 2021

Related U.S. Application Data
(60) Provisional application No. 63/114,135, filed on Nov. 16, 2020.

(51) Int. Cl. H04L 12/26; H04W 4/70; H04L 12/24

(52) U.S. Cl. CPC H04L 43/16; H04L 41/0681; H04W 4/70

(57) ABSTRACT

The present disclosure relates to detecting an abnormal behaviour in a machine-to-machine (M2M) system. A method for operating a first device may include receiving, from a second device, a request message related to a detection of an abnormal behaviour in a target device and, when the abnormal behaviour is detected, transmitting a notification of the occurrence of the abnormal behaviour to the second device. The abnormal behaviour may be detected based on information that is expected to be received or is received by the first device from the target device.

### CROSS REFERENCE TO RELATED APPLICATION

The present application claims priority to a U.S. provisional application 63/114,135, filed Nov. 16, 2020, the entire contents of which are incorporated herein for all purposes by this reference.

### BACKGROUND

### Field

The present disclosure relates to a machine-to-machine (M2M) system and, more particularly, to a method and apparatus for detecting an abnormal behaviour of a device in an M2M system.

### Description of the Related Art

Recently, Machine-to-Machine (M2M) systems have been introduced. An M2M communication may refer to a communication performed between machines without human intervention. M2M may refer to Machine Type Communication (MTC), Internet of Things (IoT) or Device-to-Device (D2D). In the following description, the term “M2M” is uniformly used for convenience of explanation, but the present disclosure is not limited thereto. A terminal used for M2M communication may be an M2M terminal or an M2M device. An M2M terminal may generally be a device having low mobility while transmitting a small amount of data. Herein, the M2M terminal may be used in connection with an M2M server that centrally stores and manages inter-machine communication information. In addition, an M2M terminal may be applied to various systems such as object tracking, automobile linkage, and power metering.

Meanwhile, with respect to an M2M terminal, the oneM2M standardization organization provides requirements for M2M communication, things to things communication and IoT technology, and technologies for architecture, Application Program Interface (API) specifications, security solutions and interoperability. The specifications of the oneM2M standardization organization provide a framework to support a variety of applications and services such as smart cities, smart grids, connected cars, home automation, security and health.

### SUMMARY

The present disclosure is directed to provide a method and apparatus for detecting an abnormal behaviour of a device in a machine-to-machine (M2M) system.

The present disclosure provides a method and apparatus for creating attributes related to a detection of an abnormal behaviour of a device in an M2M system.

The present disclosure provides a method and apparatus for notifying the occurrence of an abnormal behaviour of a device in an M2M system.

According to an embodiment of the present disclosure, a method for operating a first device in an M2M system may include receiving, from a second device, a request message related to a detection of an abnormal behaviour in a target device and, when the abnormal behaviour is detected, transmitting, to the second device, a notification of occurrence of the abnormal behaviour, in response to detecting the abnormal behaviour. The abnormal behaviour may be detected based on information that is expected to be received or is received by the first device from the target device.

According to an embodiment of the present disclosure, a method for operating a second device in an M2M system may include transmitting, to a first device, a request message related to a detection of an abnormal behaviour in a target device and receiving a notification of the occurrence of the abnormal behaviour from the first device. The abnormal behaviour may be detected based on information that is expected to be received or is received by the first device from the target device.

According to an embodiment of the present disclosure, a first device in an M2M system includes a transceiver and a processor coupled with the transceiver and configured to receive a request message related to a detection of an abnormal behaviour in a target device from a second device and, transmit, to the second device, a notification of occurrence of the abnormal behaviour, in response to detecting the abnormal behaviour. The abnormal behaviour may be detected based on information that is expected to be received or is received by the first device from the target device.

According to the present disclosure, a status (e.g., abnormal behaviour) of a device in an M2M system may be effectively monitored.

### BRIEF DESCRIPTION OF THE FIGURES

The above and other objects, features and advantages of the present disclosure will be more clearly understood from the following detailed description taken in conjunction with the accompanying drawings, in which:

FIG. 1 illustrates a layered structure of a machine-to-machine (M2M) system according to the present disclosure.

FIG. 2 illustrates a reference point in an M2M system according to the present disclosure.

FIG. 3 illustrates each node in an M2M system according to the present disclosure.

FIG. 4 illustrates a common service function in an M2M system according to the present disclosure.

FIG. 5 illustrates a method in which an originator and a receiver exchange a message in an M2M system according to the present disclosure.

FIG. 6 illustrates an example procedure of monitoring an abnormal behaviour in an M2M system according to the present disclosure.

FIG. 7 illustrates an example procedure of requesting to monitor an abnormal behaviour in an M2M system according to the present disclosure.

FIG. 8 illustrates an example procedure of detecting and reporting an abnormal behaviour in an M2M system according to the present disclosure.

FIG. 9 illustrates an example scenario of monitoring an abnormal behaviour in an M2M system according to the present disclosure.

FIG. 10 illustrates another example scenario of monitoring an abnormal behaviour in an M2M system according to the present disclosure.

FIG. 11 illustrates a configuration of an M2M apparatus in an M2M system according to the present disclosure.

### DETAILED DESCRIPTION

Hereinafter, embodiments of the present disclosure will be described in detail with reference to the accompanying drawings, which will be easily implemented by those skilled in the art. However, the present disclosure may be embodied in many different forms and is not limited to the exemplary embodiments described herein.

In the present disclosure, the terms first, second, etc. are used only for the purpose of distinguishing one component from another, and do not limit the order or importance of components, etc. unless specifically stated otherwise. Thus, within the scope of this disclosure, a first component in one embodiment may be referred to as a second component in another embodiment, and similarly a second component in one embodiment may be referred to as a first component.

In the present disclosure, when a component is referred to as being “linked”, “coupled”, or “connected” to another component, it is understood that not only a direct connection relationship but also an indirect connection relationship through an intermediate component may also be included. Also, when a component is referred to as “comprising” or “having” another component, it may mean further inclusion of another component not the exclusion thereof, unless explicitly described to the contrary.

In the present disclosure, components that are distinguished from each other are intended to clearly illustrate each feature. However, it does not necessarily mean that the components are separate. In other words, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. Also, exemplary embodiments that include other components in addition to the components described in the various exemplary embodiments are also included in the scope of the present disclosure.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

In addition, the present specification describes a network based on Machine-to-Machine (M2M) communication, and a work in M2M communication network may be performed in a process of network control and data transmission in a system managing the communication network. In the present specification, an M2M terminal may be a terminal performing M2M communication. However, in consideration of backward compatibility, it may be a terminal operating in a wireless communication system. In other words, an M2M terminal may refer to a terminal operating based on M2M communication network but is not limited thereto. An M2M terminal may operate based on another wireless communication network and is not limited to the exemplary embodiment described above.

In addition, an M2M terminal may be fixed or have mobility. An M2M server refers to a server for M2M communication and may be a fixed station or a mobile station. In the present specification, an entity may refer to hardware like M2M device, M2M gateway and M2M server. In addition, for example, an entity may be used to refer to software configuration in a layered structure of M2M system and is not limited to the embodiment described above.

In addition, for example, the present disclosure mainly describes an M2M system but is not solely applied thereto. In addition, an M2M server may be a server that performs communication with an M2M terminal or another M2M server. In addition, an M2M gateway may be a connection point between an M2M terminal and an M2M server. For example, when an M2M terminal and an M2M server have different networks, the M2M terminal and the M2M server may be connected to each other through an M2M gateway. Herein, for example, both an M2M gateway and an M2M server may be M2M terminals and are not limited to the embodiment described above.

The present disclosure relates to a method and apparatus for detecting an abnormal behaviour of a device in an M2M system. Particularly, the present disclosure describes a technique for setting information associated with abnormal behaviour detection for a device in an M2M system, detecting an abnormal behaviour based on the set information and notifying the detected abnormal behaviour.

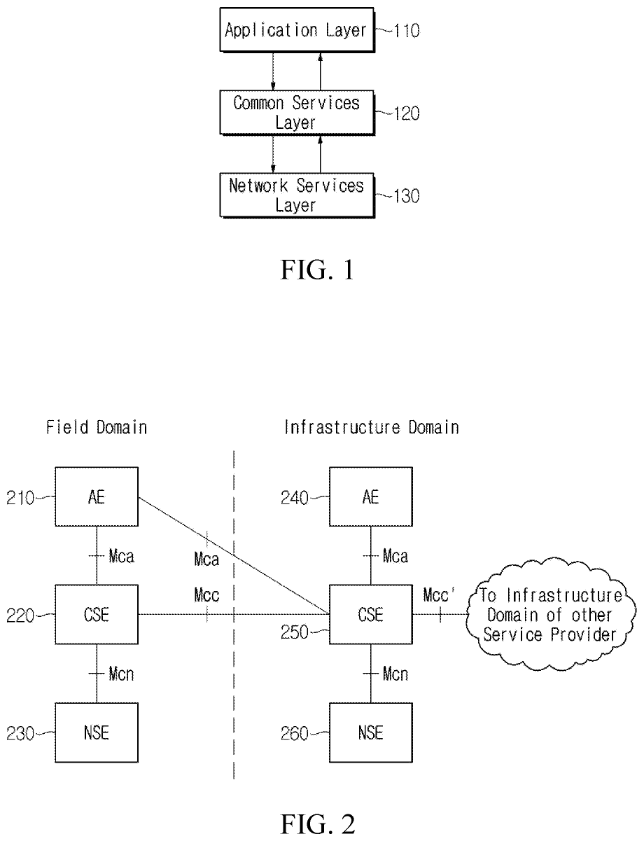

Further, oneM2M is a de facto standards organization that was founded to develop a communal IoT service platform sharing and integrating application service infrastructure (platform) environments beyond fragmented service platform development structures limited to separate industries like energy, transportation, national defense and public service.oneM2M aims to render requirements for things to things communication and IoT technology, architectures, Application Program Interface (API) specifications, security solutions and interoperability. For example, the specifications of oneM2M provide a framework to support a variety of applications and services such as smart cities, smart grids, connected cars, home automation, security and health. In this regard, oneM2M has developed a set of standards defining a single horizontal platform for data exchange and sharing among all the applications. Applications across different industrial sections may also be considered by oneM2M. Like an operating system, oneM2M provides a framework connecting different technologies, thereby creating distributed software layers facilitating unification. Distributed software layers are implemented in a common services layer between M2M applications and communication Hardware/Software (HW/SW) rendering data transmission. For example, a common services layer may be a part of a layered structure illustrated in FIG. 1.

FIG. 1 is a view illustrating a layered structure of a Machine-to-Machine (M2M) system according to the present disclosure. Referring to FIG. 1, a layered structure of an M2M system may include an application layer 110, a common services layer 120 and a network services layer 130. Herein, the application layer 110 may be a layer operating based on a specific application. For example, an application may be a fleet tracking application, a remote blood sugar monitoring application, a power metering application or a controlling application. In other words, an application layer may a layer for a specific application. Herein, an entity operating based on an application layer may be an application entity (AE).

The common services layer 120 may be a layer for a common service function (CSF). For example, the common services layer 120 may be a layer for providing common services like data management, device management, M2M service subscription management and location service. For example, an entity operating based on the common services layer 120 may be a common service entity (CSE).

The common services layer 120 may provide a set of services that are grouped into CSFs according to functions. A multiplicity of instantiated CSFs constitutes CSEs. CSEs may interface with applications (for example, application entities or AEs in the terminology of oneM2M), other CSEs and base networks (for example, network service entities or NSEs in the terminology of oneM2M). The network services layer 130 may provide the common services layer 120 with services such as device management, location service and device triggering. Herein, an entity operating based on the network layer 120 may be a network service entity (NSE).

FIG. 2 is a view illustrating reference points in an M2M system according to the present disclosure. Referring to FIG. 2, an M2M system structure may be distinguished into a field domain and an infrastructure domain. Herein, in each domain, each of the entities may perform communication through a reference point (for example, Mca or Mcc). For example, a reference point may indicate a communication flow between each entity. In particular, referring to FIG. 2, the reference point Mca between AE 210 or 240 and CSE 220 or 250, the reference point Mcc between different CSEs and Mcn reference point between CSE 220 or 250 and NSE 230 or 260 may be set.

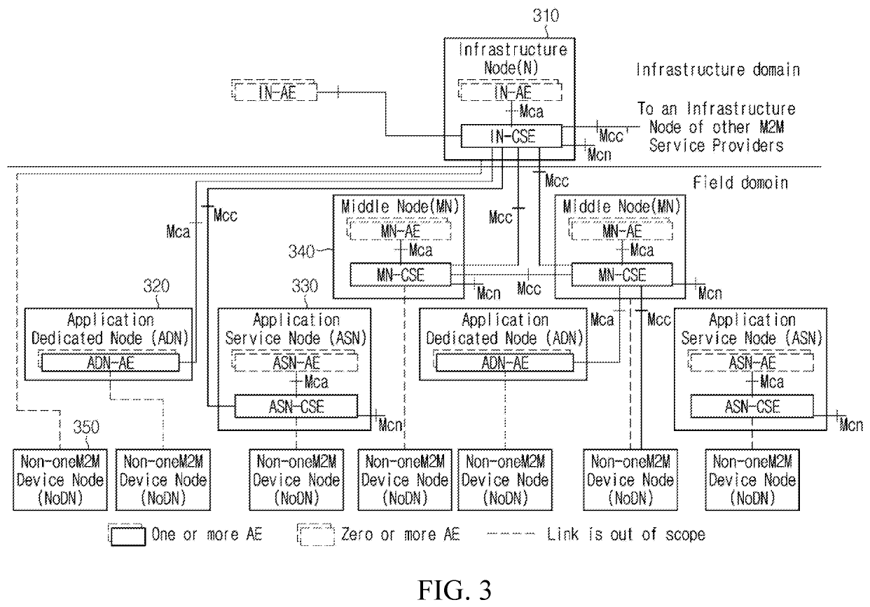

FIG. 3 is a view illustrating each node in an M2M system according to the present disclosure. Referring to FIG. 3, an infrastructure domain of a specific M2M service provider may provide a specific infrastructure node (IN) 310. Herein, the CSE of the IN may be configured to perform communication based on the AE and the reference point Mca of another infrastructure node. In particular, one IN may be set for each M2M service provider. In other words, the IN may be a node that performs communication with the M2M terminal of another infrastructure based on an infrastructure structure. In addition, for example, conceptually, a node may be a logical entity or a software configuration.

Next, an application dedicated node (ADN) 320 may be a node including at least one AE but not CSE. In particular, an ADN may be set in the field domain. In other words, an ADN may be a dedicated node for AE. For example, an ADN may be a node that is set in an M2M terminal in hardware. In addition, the application service node (ASN) 330 may be a node including one CSE and at least one AE. ASN may be set in the field domain. In other words, it may be a node including AE and CSE. In particular, an ASN may be a node connected to an IN. For example, an ASN may be a node that is set in an M2M terminal in hardware.

In addition, a middle node (MN) 340 may be a node including a CSE and including zero or more AEs. In particular, the MN may be set in the field domain. An MN may be connected to another MN or IN based on a reference point. In addition, for example, an MN may be set in an M2M gateway in hardware. As an example, a non-M2M terminal node 350 (Non-M2M device node, NoDN) is a node that does not include M2M entities. It may be a node that performs management or collaboration together with an M2M system.

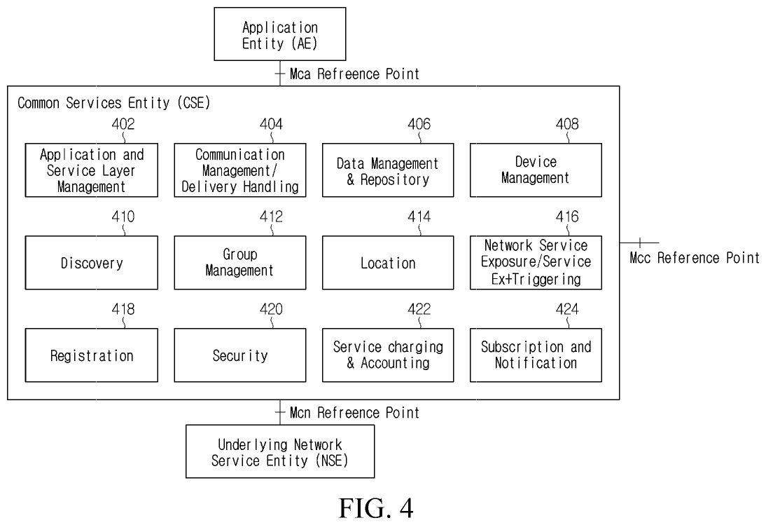

FIG. 4 is a view illustrating a common service function in an M2M system according to the present disclosure. Referring to FIG. 4, common service functions may be provided. For example, a common service entity may provide at least one or more CSFs among application and service layer management 402, communication management and delivery handling 404, data management and repository 406, device management 408, discovery 410, group management 412, location 414, network service exposure/service execution and triggering 416, registration 418, security 420, service charging and accounting 422, service session management and subscription/notification 424. At this time, M2M terminals may operate based on a common service function. In addition, a common service function may be possible in other embodiments and is not limited to the above-described exemplary embodiment.

The application and service layer management 402 CSF provides management of AEs and CSEs. The application and service layer management 402 CSF includes not only the configuring, problem solving and upgrading of CSE functions but also the capability of upgrading AEs. The communication management and delivery handling 404 CSF provides communications with other CSEs, AEs and NSEs. The communication management and delivery handling 404 CSF are configured to determine at what time and through what connection communications are to be delivered, and also determine to buffer communication requests to deliver the communications later, if necessary and permitted.

The data management and repository 406 CSF provides data storage and transmission functions (for example, data collection for aggregation, data reformatting, and data storage for analysis and sematic processing). The device management 408 CSF provides the management of device capabilities in M2M gateways and M2M devices.

The discovery 410 CSF is configured to provide an information retrieval function for applications and services based on filter criteria. The group management 412 CSF provides processing of group-related requests. The group management 412 CSF enables an M2M system to support bulk operations for many devices and applications. The location 414 CSF is configured to enable AEs to obtain geographical location information.

The network service exposure/service execution and triggering 416 CSF manages communications with base networks for access to network service functions. The registration 418 CSF is configured to provide AEs (or other remote CSEs) to a CSE. The registration 418 CSF allows AEs (or remote CSE) to use services of CSE. The security 420 CSF is configured to provide a service layer with security functions like access control including identification, authentication and permission. The service charging and accounting 422 CSF is configured to provide charging functions for a service layer. The subscription/notification 424 CSF is configured to allow subscription to an event and notifying the occurrence of the event.

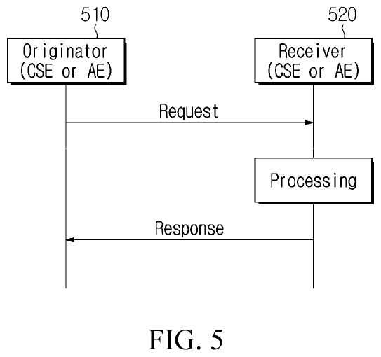

FIG. 5 is a view illustrating that an originator and a receiver exchange a message in an M2M system according to the present disclosure. Referring to FIG. 5, the originator 501 may be configured to transmit a request message to the receiver 520. In particular, the originator 510 and the receiver 520 may be the above-described M2M terminals. However, the originator 510 and the receiver 520 are not limited to M2M terminals but may be other terminals. They are not limited to the above-described exemplary embodiment. In addition, for example, the originator 510 and the receiver 520 may be nodes, entities, servers or gateways, which are described above. In other words, the originator 510 and the receiver 520 may be hardware or software configurations and are not limited to the above-described embodiment.

Herein, for example, a request message transmitted by the originator 510 may include at least one parameter. Additionally, a parameter may be a mandatory parameter or an optional parameter. For example, a parameter related to a transmission terminal, a parameter related to a receiving terminal, an identification parameter and an operation parameter may be mandatory parameters. In addition, optional parameters may be related to other types of information. In particular, a transmission terminal-related parameter may be a parameter for the originator 510. In addition, a receiving terminal-related parameter may be a parameter for the receiver 520. An identification parameter may be a parameter required for identification of each other.

Further, an operation parameter may be a parameter for distinguishing operations. For example, an operation parameter may be set to any one among Create, Retrieve, Update, Delete and Notify. In other words, the parameter may aim to distinguish operations. In response to receiving a request message from the originator 510, the receiver 520 may be configured to process the message. For example, the receiver 520 may be configured to perform an operation included in a request message. For the operation, the receiver 520 may be configured to determine whether a parameter is valid and authorized. In particular, in response to determining that a parameter is valid and authorized, the receiver 520 may be configured to check whether there is a requested resource and perform processing accordingly.

For example, in case an event occurs, the originator 510 may be configured to transmit a request message including a parameter for notification to the receiver 520. The receiver 520 may be configured to check a parameter for a notification included in a request message and may perform an operation accordingly. The receiver 520 may be configured to transmit a response message to the originator 510.

A message exchange process using a request message and a response message, as illustrated in FIG. 5, may be performed between AE and CSE based on the reference point Mca or between CSEs based on the reference point Mcc. In other words, the originator 510 may be AE or CSE, and the receiver 520 may be AE or CSE. According to an operation in a request message, such a message exchange process as illustrated in FIG. 5 may be initiated by either AE or CSE.

A request from a requestor to a receiver through the reference points Mca and Mcc may include at least one mandatory parameter and at least one optional parameter. In other words, each defined parameter may be either mandatory or optional according to a requested operation. For example, a response message may include at least one parameter among those listed in Table 1 below.

TABLE 1
Response message parameter/success or not

Response Status Code - successful, unsuccessful, ack
Request Identifier - uniquely identifies a Request message
Content - to be transferred
To - the identifier of the Originator or the Transit CSE that sent the corresponding non-blocking request
From - the identifier of the Receiver
Originating Timestamp - when the message was built
Result Expiration Timestamp - when the message expires
Event Category - what event category shall be used for the response message
Content Status
Content Offset
Token Request Information
Assigned Token Identifiers
Authorization Signature Request Information
Release Version Indicator - the oneM2M release version that this response message conforms to

A filter criteria condition, which can be used in a request message or a response message, may be defined as in Table 2 and Table 3 below.

TABLE 2

| | | |
|---|---|---|
| Condition tag | Multiplicity | Description |

Matching Conditions

| | | |
|---|---|---|
| createdBefore | 0..1 | The creationTime attribute of the matched resource is chronologically before the |
| | | specified value. |
| createdAfter | 0..1 | The creationTime attribute of the matched resource is chronologically after the |
| | | specified value. |
| modifiedSince | 0..1 | The lastModifiedTime attribute of the matched resource is chronologically after |
| | | the specified value. |
| unmodifiedSince | 0..1 | The lastModifiedTime attribute of the matched resource is chronologically |
| | | before the specified value. |
| stateTagSmaller | 0..1 | The stateTag attribute of the matched resource is smaller than the specified |
| | | value. |
| stateTagBigger | 0..1 | The stateTag attribute of the matched resource is bigger than the specified value. |
| expireBefore | 0..1 | The expirationTime attribute of the matched resource is chronologically before |
| | | the specified value. |
| expireAfter | 0..1 | The expirationTime attribute of the matched resource is chronologically after the |
| | | specified value. |
| labels | 0..1 | The labels attribute of the matched resource matches the specified value. |
| labelsQuery | 0..1 | The value is an expression for the filtering of labels attribute of resource when it |
| | | is of key-value pair format. The expression is about the relationship between |
| | | label-key and label-value which may include equal to or not equal to, within or |
| | | not within a specified set etc. For example, label-key equals to label value, or |
| | | label-key within {label-value1, label-value2}. Details are defined in [3] |
| childLabels | 0..1 | A child of the matched resource has labels attributes matching the specified |
| | | value. The evaluation is the same as for the labels attribute above. Details are |
| | | defined in [3]. |
| parentLabels | 0..1 | The parent of the matched resource has labels attributes matching the specified |
| | | value. The evaluation is the same as for the labels attribute above. Details are |
| | | defined in [3]. |
| resourceType | 0..n | The resourceType attribute of the matched resource is the same as the specified |
| | | value. It also allows differentiating between normal and announced resources |
| childResourceType | 0..n | A child of the matched resource has the resourceType attribute the same as the |
| | | specified value. |
| parentResourceType | 0..1 | The parent of the matched resource has the resourceType attribute the same as |
| | | the specified value. |
| sizeAbove | 0..1 | The contentSize attribute of the <contentInstance> matched resource is equal to |
| | | or greater than the specified value. |
| sizeBelow | 0..1 | The contentSize attribute of the <contentInstance> matched resource is smaller |
| | | than the specified value. |
| contentType | 0..n | The contentInfo attribute of the <contentInstance> matched resource matches |
| | | the specified value. |
| attribute | 0..n | This is an attribute of resource types (clause 9.6). Therefore, a real tag name is |
| | | variable and depends on its usage and the value of the attribute can have wild |
| | | card *. E.g. creator of container resource type can be used as a filter criteria tag |
| | | as ″creator=Sam″, ″creator=Sam*″, ″creator=*Sam″. |
| childAttribute | 0..n | A child of the matched resource meets the condition provided. The evaluation of |
| | | this condition is similar to the attribute matching condition above. |
| parentAttribute | 0..n | The parent of the matched resource meets the condition provided. The |
| | | evaluation of this condition is similar to the attribute matching condition above. |
| semanticsFilter | 0..n | Both semantic resource discovery and semantic query use semanticsFilter to |
| | | specify a query statement that shall be specified in the SPARQL query language |
| | | [5]. When a CSE receives a RETRIEVE request including a semanticsFilter, and |
| | | the Semantic Query Indicator parameter is also present in the request, the |
| | | request shall be processed as a semantic query; otherwise, the request shall be |
| | | processed as a semantic resource discovery. |
| | | In the case of semantic resource discovery targeting a specific resource, if the |
| | | semantic description contained in the <semanticDescriptor> of a child resource |
| | | matches the semanticFilter, the URI of this child resource will be included in the |
| | | semantic resource discovery result. |
| | | In the case of semantic query, given a received semantic query request and its |
| | | query scope, the SPARQL query statement shall be executed over aggregated |
| | | semantic information collected from the semantic resource(s) in the query scope |
| | | and the produced output will be the result of this semantic query. |
| | | Examples for matching semantic filters in SPARQL to semantic descriptions can |
| | | be found in [i.28]. |
| filterOperation | 0..1 | Indicates the logical operation (AND/OR) to be used for different condition tags. |
| | | The default value is logical AND. |
| contentFilterSyntax | 0..1 | Indicates the Identifier for syntax to be applied for content-based discovery. |
| contentFilterQuery | 0..1 | The query string shall be specified when contentFilterSyntax parameter is |
| | | present. |

TABLE 3

| | | |
|---|---|---|
| Condition tag | Multiplicity | Description |

Filter Handling Conditions

| | | |
|---|---|---|
| filterUsage | 0..1 | Indicates how the filter criteria is used. If provided, possible values are |
| | | ′discovery′ and ′IPEOnDemandDiscovery′. |
| | | If this parameter is not provided, the Retrieve operation is a generic retrieve |
| | | operation and the content of the child resources fitting the filter criteria is |
| | | returned. |
| | | If filterUsage is ′discovery′, the Retrieve operation is for resource discovery |
| | | (clause 10.2.6), i.e. only the addresses of the child resources are returned. |
| | | If filterUsage is ′IPEOnDemandDiscovery′, the other filter conditions are sent to |
| | | the IPE as well as the discovery Originator ID. When the IPE successfully |
| | | generates new resources matching with the conditions, then the resource |
| | | address(es) shall be returned. This value shall only be valid for the Retrieve |
| | | request targeting an <AE> resource that represents the IPE. |
| limit | 0..1 | The maximum number of resources to be included in the filtering result. This |
| | | may be modified by the Hosting CSE. When it is modified, then the new value |
| | | shall be smaller than the suggested value by the Originator. |
| level | 0..1 | The maximum level of resource tree that the Hosting CSE shall perform the |
| | | operation starting from the target resource (i.e. To parameter). This shall only be |
| | | applied for Retrieve operation. The level of the target resource itself is zero and |
| | | the level of the direct children of the target is one. |
| offset | 0..1 | The number of direct child and descendant resources that a Hosting CSE shall |
| | | skip over and not include within a Retrieve response when processing a Retrieve |
| | | request to a targeted resource. |
| applyRelativePath | 0..1 | This attribute contains a resource tree relative path (e.g. ../ |
| | | tempContainer/LATEST). This condition applies after all the matching |
| | | conditions have been used (i.e. a matching result has been obtained). The |
| | | attribute determines the set of resource(s) in the final filtering result. The |
| | | filtering result is computed by appending the relative path to the path(s) in the |
| | | matching result. All resources whose Resource-IDs match that combined path(s) |
| | | shall be returned in the filtering result. If the relative path does not represent a |
| | | valid resource, the outcome is the same as if no match was found, i.e. there is no |
| | | corresponding entry in the filtering result. |

A response to a request for accessing a resource through the reference points Mca and Mcc may include at least one mandatory parameter and at least one optional parameter. In other words, each defined parameter may be either mandatory or optional according to a requested operation or a mandatory response code. For example, a request message may include at least one parameter among those listed in Table 4 below.

TABLE 4
Request message parameter

| | |
|---|---|
| Mandatory | Operation - operation to be executed/CREAT, Retrieve, Update, Delete, Notify |
| | To - the address of the target resource on the target CSE |
| | From - the identifier of the message Originator |
| | Request Identifier - uniquely identifies a Request message |
| Operation | Content - to be transferred |
| dependent | Resource Type - of resource to be created |
| Optional | Originating Timestamp - when the message was built |
| | Request Expiration Timestamp - when the request message expires |
| | Result Expiration Timestamp - when the result message expires |
| | Operational Execution Time - the time when the specified operation is to be executed by the target CSE |
| | Response Type - type of response that shall be sent to the Originator |
| | Result Persistence - the duration for which the reference containing the responses is to persist |
| | Result Content - the expected components of the result |
| | Event Category - indicates how and when the system should deliver the message |
| | Delivery Aggregation - aggregation of requests to the same target CSE is to be used |
| | Group Request Identifier - Identifier added to the group request that is to be fanned out to each member |
| | of the group |
| | Group Request Target Members-indicates subset of members of a group |
| | Filter Criteria - conditions for filtered retrieve operation |
| | Desired Identifier Result Type - format of resource identifiers returned |
| | Token Request Indicator - indicating that the Originator may attempt Token Request procedure (for |
| | Dynamic Authorization) if initiated by the Receiver |
| | Tokens - for use in dynamic authorization |
| | Token IDs - for use in dynamic authorization |
| | Role IDs - for use in role based access control |
| | Local Token IDs - for use in dynamic authorization |
| | Authorization Signature Indicator - for use in Authorization Relationship Mapping |
| | Authorization Signature - for use in Authorization Relationship Mapping |
| | Authorization Relationship Indicator - for use in Authorization Relationship Mapping |
| | Semantic Query Indicator - for use in semantic queries |
| | Release Version Indicator - the oneM2M release version that this request message conforms to. |
| | Vendor Information |

A normal resource includes a complete set of representations of data constituting the base of information to be managed. Unless qualified as either “virtual” or “announced”, the resource types in the present document are normal resources. A virtual resource is used to trigger processing and/or a retrieve result. However, a virtual resource does not have a permanent representation in a CSE. An announced resource contains a set of attributes of an original resource. When an original resource changes, an announced resource is automatically updated by the hosting CSE of the original resource. The announced resource contains a link to the original resource. Resource announcement enables resource discovery. An announced resource at a remote CSE may be used to create a child resource at a remote CSE, which is not present as a child of an original resource or is not an announced child thereof.

To support resource announcement, an additional column in a resource template may specify attributes to be announced for inclusion in an associated announced resource type. For each announced <resourceType>, the addition of suffix “Annc” to the original <resourceType>may be used to indicate its associated announced resource type. For example, resource <containerAnnc>may indicate the announced resource type for <container>resource, and <groupAnnc>may indicate the announced resource type for <group>resource.

In the IoT world, many IoT systems provide a function to detect any update of IoT resources. For example, there is a subscription/notification feature that sends information to subscribed applications when there is any change on the target resource. If the target resource is updated with a new value, all the subscribed applications obtain notification about the update. There also exist a feature called ‘expirationTime’. The ‘expirationTime’ feature is suggested to identify how long a resource can exist. After the given amount of time, the resource is not valid anymore.

The above-described features, such as subscription/notification and expiration timer, are used by many IoT applications. However, there is a case that an IoT application needs to know about that the target IoT device is not working properly for a certain amount of time so that the device can be replaced. The current oneM2M system does not support this feature.

Hence, the present disclosure proposes an idle timer to enable a system to check whether or not a target IoT device is still working properly. The idle timer may be used to check whether or not the device needs to be replaced. For example, if a device is not able to send its status to the IoT system because of its low battery, the resource cannot be updated on time. In this case, the system may report this behaviour to the IoT application.

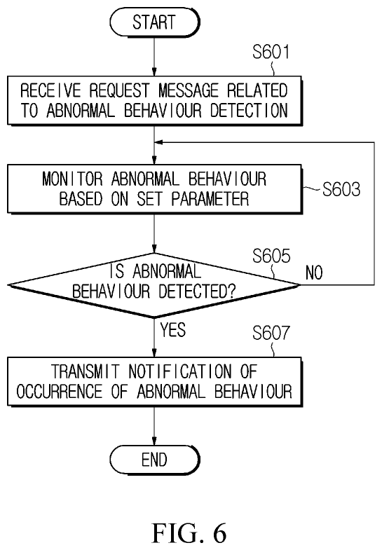

FIG. 6 illustrates an example procedure of monitoring an abnormal behaviour in an M2M system according to the present disclosure. FIG. 6 exemplifies a method for operating a device that identifies an abnormal behaviour of a target device and notifies the occurrence of the abnormal behaviour to a requesting device.

Referring to FIG. 6, in step S601, the device receives a request message related to an abnormal behaviour detection. The request message may be received from a target device or a device (hereinafter ‘request device’) different from the target device. The request message may include at least one parameter related to abnormal behaviour detection or information for determining at least one parameter. Although not shown in FIG. 6, in response to receiving the request message, the device may set at least one parameter (e.g., attribute) for monitoring an abnormal behaviour.

In step S603, the device monitors an abnormal behaviour based on at least one set parameter. After setting at least one parameter in response to receiving the request message, the device may determine whether or not an abnormal behaviour occurs according to a condition specified by the at least one parameter that is set. For example, the at least one parameter may include at least one among a parameter indicating the target device, a parameter indicating the request device, a parameter indicating a type of an abnormal behaviour, a parameter indicating a reporting condition (e.g., number of events) of the abnormal behaviour, and a parameter for counting an event corresponding to the type. That is, the device may collect information on at least one parameter and compare a situation specified by the collected information with a condition.

In step S605, the device determines whether or not an abnormal behaviour is detected. In other words, the device may determine whether or not a current situation satisfies the reporting condition of an abnormal behaviour. For example, an abnormal behaviour may be determined based on non-reception of information to be received from the target device, reception of false information and the like. That is, an abnormal behaviour may be detected based on information that is expected to be received or is received by the device from the target device. When no abnormal behaviour is detected, the device returns to step S603 and proceeds to monitor an abnormal behaviour.

When an abnormal behaviour is detected, in step S607, the device transmits a notification of the occurrence of an abnormal behaviour. Specifically, the device checks a requesting device indicated by at least one parameter and transmits a notification message to the requesting device. The notification message may include at least one of information on the target device and information associated with the detected abnormal behaviour.

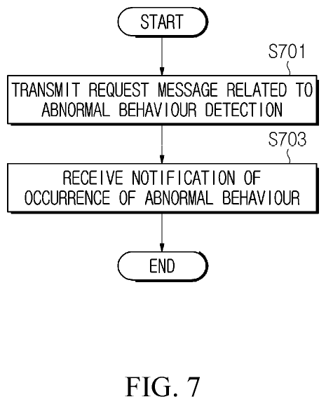

FIG. 7 illustrates an example procedure of requesting to monitor an abnormal behaviour in an M2M system according to the present disclosure. FIG. 7 exemplifies a method of operating a device that requests to notify when an abnormal behaviour of a target device occurs.

Referring to FIG. 7, in step S701, a device transmits a request message related to an abnormal behaviour dectection. The request message may include at least one parameter related to abnormal behaviour detection or information for determining at least one parameter. For example, the at least one parameter may include at least one among a parameter indicating the target device, a parameter indicating the requesting device, a parameter indicating a type of an abnormal behaviour, a parameter indicating a reporting condition (e.g., number of events) of the abnormal behaviour, and a parameter for counting an event corresponding to the type.

In step S703, the device receives a notification about the occurrence of an abnormal behaviour. Thus, the device is capable of confirming the abnormal behaviour of the target device. The notification message may include at least one of information on the target device and information associated with the detected abnormal behaviour. Although not shown in FIG. 7, the device may further perform a subsequent operation after the abnormal behaviour is confirmed.

As described with reference to FIG. 7, the device may request another device to monitor the target device as regards an abnormal behaviour. Herein, when it is notified that the abnormal behaviour is detected, the device may perform a subsequent operation. For example, the device may output a notification to inform a user of the device of the abnormal behaviour of the target device. The notification may be output through an indication means or an audio means or be transmitted out through a communication means. The notification may enable the user to recognize the occurrence of the abnormal behaviour and to take action such as replacement of device.

As described with reference to FIG. 6 and FIG. 7, monitoring of an abnormal behaviour may be performed at the request of any device, and the monitoring result may be notified. To this end, at least one parameter, that is, at least one attribute may be used. At least one attribute thus used may be defined in various ways according to the definition of an abnormal behaviour. For example, an abnormal behaviour may include a predetermined or larger number of consecutive events where information with periodicity is not received from a target device within a predetermined time. In this case, at least one of the attributes listed in Table 5 below may be used.

TABLE 5

| Attribute | Description |
|---|---|
| nextModifyTime | nextModifyTime attribute indicates next expected update |
| | time/date of the resource. nextModifyTime attribute may be |
| | provided by the originator, and in this case, the attribute may be |
| | regarded as a hint to a hosting CSE when the resource is supposed |
| | to be updated to check whether or not a corresponding IoT device |
| | or application is properly working. The nextModifyTime attribute |
| | may be used by an IoT application that regularly sends |
| | measurement to an IoT platform. |
| missedNextModityTime | missedNextModifyTime attribute specifies the number of |
| | modifications that missed the time specified in the |
| | nextModifyTime attribute. |
| nextModifyWindow | nextModifyWindow attribute specifies the number of |
| | modifications that are allowed to be missed. When the number of |
| | missed modifications is less than a window, the notification may |
| | not be issued. The number of modifications specified by the |
| | nextModifyWindow attribute means a threshold amount of times |
| | for detecting the abnormal behaviour. |

When the resource is not updated as expected within the specified time in the nextModifyTimer attribute, then the hosting CSE may notify this information to its IoT application. Accordingly, the owner of the IoT application is able to check the status of the device. Unless the device has a low battery, the owner may replace the battery.

The names of the attributes illustrated in Table 5 are mere examples, and the attributes may be defined by different names according to specific embodiments. In accordance with various embodiments, apart from the attributes listed in Table 5, another attribute may be used. For example, the another attribute may include an attribute specifying an abnormal behaviour.

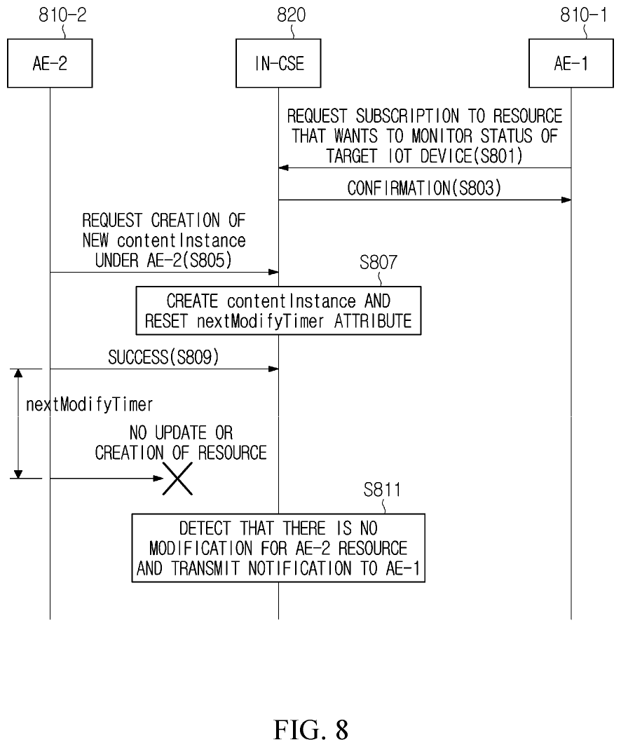

FIG. 8 illustrates an example procedure of detecting and reporting an abnormal behaviour in an M2M system according to the present disclosure. FIG. 8 exemplifies exchanges of signals among AE-1 810-1, AE-2 810-2, and IN-CSE 820. In FIG. 8, AE-1 810-1 is an object that requests monitoring, AE-2 810-2 is an object to be monitored, and IN-CSE 820 is an object that performs monitoring.

Referring to FIG. 8, in step S801, AE-1 810-1 transmits a request message for subscribing to a resource, for which the status monitoring of a target IoT device (e.g., AE-2 810-2) is desired, to IN-CSE 820. In step S803, IN-CSE 820 transmits a confirmation message to AE-1 810-1. For example, the confirmation message may include a 200 OK message.

In step S805, AE-2 810-2 transmits a creation request message about new contentInstance related to AE-2 810-2. The creation request message requests to create the new contentInstance resource under a container for AE-2 810-2.

In step S807, IN-CSE 820 creates the contentInstance and resets the nextModifyTimer attribute. That is, in response to the creation request message from AE-2 810-2, IN-CSE 820 creates the contentInstance related to AE-2 810-2. In addition, IN-CSE 820 may recognize the creation of resource for AE-2 810-2, a target of monitoring requested by AE-1 810-1, and initialize the value of at least one attribute related to monitoring.

In step S809, IN-CSE 820 transmits a success message to AE-2 810-2. Thus, AE-2 810-2 is capable of recognizing that the requested resource is created by IN-CSE 820. In the case of FIG. 8, no update or creation of resource is notified until the expiration of nextModifyTimer.

In step S811, IN-CSE 820 detects that there is no modification for the resource for AE-2 810-2, and then transmits a notification to AE-1 810-1. In other words, as no update or creation of resource is notified until the expiration of nextModityTimer, IN-CSE 820 determines that an abnormal behaviour occurs in AE-2 810-2. In addition, IN-CSE 820 transmits, to AE-1 810-1, a message notifying that the abnormal behaviour of AE-2 810-2 is detected.

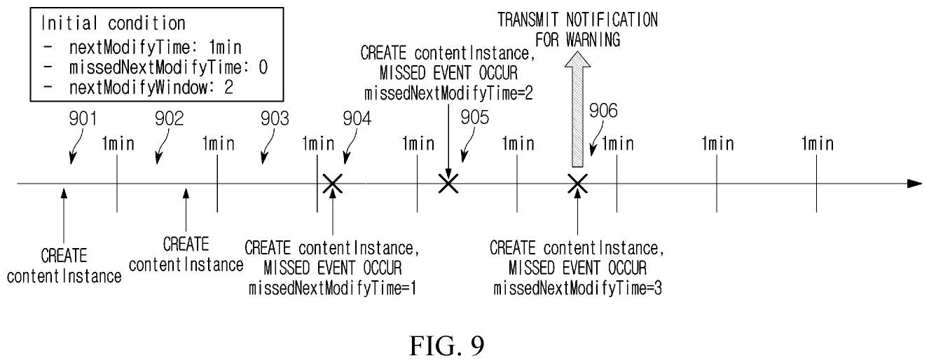

FIG. 9 illustrates an example scenario of monitoring an abnormal behaviour in an M2M system according to the present disclosure. The example of FIG. 9 illustrates a situation in which nextModifyTime is set to 1 minute, missedNextModityTime is set to 0, and nextModifyWindow is set to 2. Referring to FIG. 9, contentInstance is created at section #1 901 and at section #2 902 respectively. Next, no event occurs at section #3 903, and contentInstance is created at section #4 904 and at section #5 905 but is not forwarded. The missed event occurs two times. For example, the missed event may occur because of battery discharge or drain. Accordingly, the value of missedNextModifyTime attribute is updated to 1 at section #4 904 and to 2 at section #5 905. Since the nextModifyWindow attribute has a value of 2, no abnormal behaviour is notified yet. Next, at section #6 906, although contentInstance is created, the missed event occurs again, and the missedNextModifyTime attribute has a value of 3, thereby exceeding the value of the NextModifyWindow attribute. Accordingly, an abnormal behaviour is determined to occur, and a notification for warning against the abnormal behaviour is transmitted. In other words, the situation is interpreted as an abnormal situation, and the notification is transmitted.

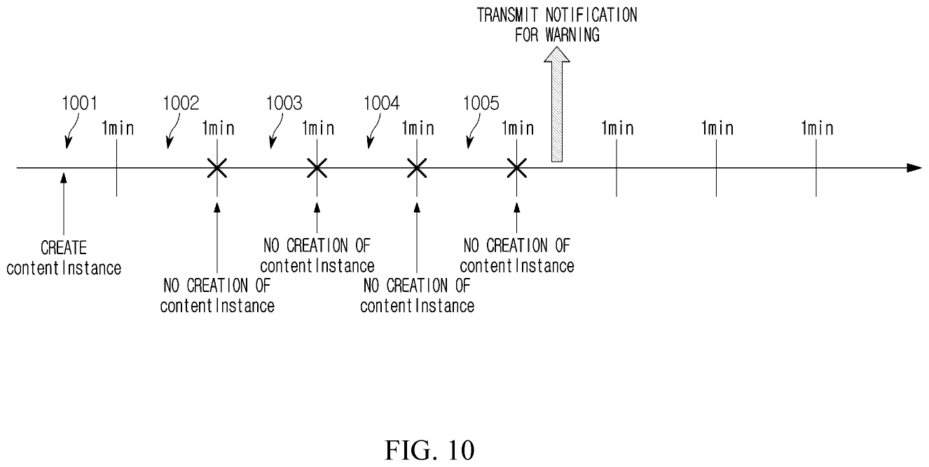

FIG. 10 illustrates another example scenario of monitoring an abnormal behaviour in an M2M system according to the present disclosure. Referring to FIG. 10, contentInstance is created at section #1 1001. Next, no additional creation or modification of contentInstance occurs between section #2 1002 and section #5 1005. In this case, since no creation or modification of contentInstance is made, no relevant signaling is performed. For example, the creation or modification of contentInstance may not occur due to battery drain and the like. No creation of contentInstance and the missed event following the creation of contentInstance act in the same way for a monitoring device of an abnormal behaviour. That is, like the scenario of FIG. 9, in the case of FIG. 10, based on the missedNextModifyTime attribute and the nextModifyWindow attribute, the occurrence of an abnormal behaviour may be determined, and a notification for warning against the abnormal behaviour may be transmitted.

In the various embodiments described above, scenarios for regular time based modification were addressed. However, an abnormal behaviour may be monitored based on various conditions. For example, requests (e.g., update request, creation request, deletion request) occurring from different locations, requests from unknown or unspecified or unauthorized users and the like may be handled as abnormal behaviours. Accordingly, the present disclosure is not limited to time-based detection, and the above-described embodiments may be extended to detect various cases. For this purpose, the ‘abnormalBehaviour’ attribute may be proposed. The abnormalBehaviour attribute provides conditions specifying abnormal behaviours and may be used for detecting an abnormal behaviour of a target IoT device. In this case, an IoT platform may provide an IoT application with information on abnormal behaviours which are caused by delayed measurement, report from a wrong location, unauthorized attempts and other various factors.

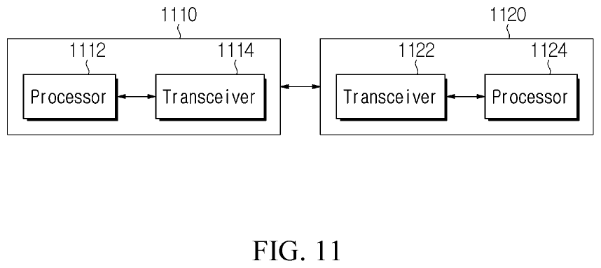

FIG. 11 illustrates a configuration of an M2M device in an M2M system according to the present disclosure. An M2M device 1110 or an M2M device 1120 illustrated in FIG. 11 may be understood as hardware functioning as at least one among the above-described AE, CSE and NSE.

Referring to FIG. 11, the M2M device 1110 may include a processor 1112 controlling a device and a transceiver 1114 transmitting and receiving a signal. Herein, the processor 1112 may control the transceiver 1114. In addition, the M2M device 1110 may communicate with a second M2M device 1120. The second M2M device 1120 may also include a processor 1122 and a transceiver 1124, and the processor 1122 and the transceiver 1124 may perform the same function as the processor 1112 and the transceiver 1114.

As an example, the originator, the receiver, AE and CSE, which are described above, may be one of the M2M devices 1110 and 1120 of FIG. 11, respectively. In addition, the devices 1110 and 1120 of FIG. 11 may be other devices. As an example, the devices 1110 and 1120 of FIG. 11 may be communication devices, vehicles, or base stations. That is, the devices 1110 and 1120 of FIG. 11 refer to devices capable of performing communication and are not limited to the above-described embodiment.

The above-described exemplary embodiments of the present disclosure may be implemented by various means. For example, the exemplary embodiments of the present disclosure may be implemented by hardware, firmware, software, or a combination thereof.

The foregoing description of the exemplary embodiments of the present disclosure has been presented for those skilled in the art to implement and perform the disclosure. While the foregoing description has been presented with reference to the preferred embodiments of the present disclosure, it will be apparent to those skilled in the art that various modifications and variations can be made in the present disclosure without departing from the spirit or scope of the present disclosure as defined by the following claims.

Accordingly, the present disclosure is not intended to be limited to the exemplary embodiments shown herein but is to be accorded the widest scope consistent with the principles and novel features disclosed herein. In addition, while the exemplary embodiments of the present specification have been particularly shown and described, it is to be understood that the present specification is not limited to the above-described exemplary embodiments, but, on the contrary, it will be understood by those skilled in the art that various changes and modifications may be made without departing from the spirit and scope of the present specification as defined by the claims below, and such changes and modifications should not be individually understood from the technical thought and outlook of the present specification.

In this specification, both the disclosure and the method disclosure are explained, and the description of both disclosures may be supplemented as necessary. In addition, the present disclosure has been described with reference to exemplary embodiments thereof. It will be understood by those skilled in the art that various changes in form and details may be made therein without departing from the essential characteristics of the present disclosure. Therefore, the disclosed exemplary embodiments should be considered in an illustrative sense rather than in a restrictive sense. The scope of the present disclosure is defined by the appended claims rather than by the foregoing description, and all differences within the scope of equivalents thereof should be construed as being included in the present disclosure.

1. A method for operating a first device in a machine-to-machine (M2M) system, the method comprising:
receiving, from a second device, a request message related to a detection of an abnormal behaviour in a target device; and
transmitting, to the second device, a notification of an occurrence of the abnormal behaviour, in response to detecting the abnormal behaviour,
wherein the abnormal behaviour is detected based on information that is expected to be received or is received by the first device from the target device.

2. The method of claim 1, wherein the abnormal behaviour comprises a predetermined or larger number of consecutive events where information with periodicity is not received from the target device within a predetermined time.

3. The method of claim 1, further comprising:
creating at least one attribute for detecting the abnormal behaviour based on the request message; and
monitoring whether the abnormal behaviour occurs based on the at least one attribute.

4. The method of claim 3, wherein the at least one attribute comprises at least one among an attribute indicating the target device, an attribute indicating the second device, an attribute indicating a type of the abnormal behaviour, an attribute indicating a reporting condition of the abnormal behaviour, and an attribute for counting an event corresponding to the type of the abnormal behaviour.

5. The method of claim 1, further comprising:
setting a timer for detecting the abnormal behaviour;
receiving a request for creating a resource from the target device;
creating the resource; and
resetting the timer.

6. The method of claim 5, wherein the abnormal behaviour is detected when an event that a request for creating a resource or for modifying a created resource is not received from the target device before the timer expires occurs a threshold amount of times or more.

7. The method of claim 6, further comprising:
creating an attribute indicating the threshold amount of times and an attribute indicating a number of times the event occurs, after receiving the request message.

8. The method of claim 1, wherein the notification comprises at least one of information on the target device and information on the abnormal behaviour.

9. A method for operating a second device in a machine-to-machine (M2M) system, the method comprising:
transmitting, to a first device, a request message related to a detection of an abnormal behaviour in a target device; and
receiving, from the first device, a notification of an occurrence of the abnormal behaviour,
wherein the abnormal behaviour is detected based on information that is expected to be received or is received by the first device from the target device.

10. The method of claim 9, wherein the abnormal behaviour comprises a predetermined or larger number of consecutive events where information with periodicity is not received from the target device within a predetermined time.

11. The method of claim 9, wherein whether or not the abnormal behaviour occurs is monitored by the first device based on at least one attribute that is created in the first device.

12. The method of claim 11, wherein the at least one attribute comprises at least one among an attribute indicating the target device, an attribute indicating the second device, an attribute indicating a type of the abnormal behaviour, an attribute indicating a reporting condition of the abnormal behaviour, and an attribute for counting an event corresponding to the type of the abnormal behaviour.

13. The method of claim 9, wherein the abnormal behaviour is detected when an event that a request for creating a resource or for modifying a created resource is not received from the target device before a timer for detecting the abnormal behaviour expires occurs a threshold amount of times or more.

14. The method of claim 9, wherein the notification comprises at least one of information on the target device and information on the abnormal behaviour.

15. A first device in a machine-to-machine (M2M) system, the first device comprising:
a transceiver; and
a processor coupled with the transceiver and configured to:
receive a request message related to a detection of an abnormal behaviour in a target device from a second device, and
transmit, to the second device, a notification of occurrence of the abnormal behaviour, in response to detecting the abnormal behaviour, and
wherein the abnormal behaviour is detected based on information that is expected to be received or is received by the first device from the target device.

16. The first device of claim 15, wherein the abnormal behaviour comprises a predetermined or larger number of consecutive events where information with periodicity is not received from the target device within a predetermined time.

17. The first device of claim 15, wherein the processor is further configured to:
create at least one attribute for detecting the abnormal behaviour based on the request message; and
monitor whether the abnormal behaviour occurs based on the at least one attribute.

18. The first device of claim 17, wherein the at least one attribute comprises at least one among an attribute indicating the target device, an attribute indicating the second device, an attribute indicating a type of the abnormal behaviour, an attribute indicating a reporting condition of the abnormal behaviour, and an attribute for counting an event corresponding to the type of the abnormal behaviour.

19. The first device of claim 15, wherein the processor is further configured to:
set a timer for detecting the abnormal behaviour,
receive a request for creating a resource from the target device,
create the resource, and
reset the timer.

20. The first device of claim 19, wherein the abnormal behaviour is detected when an event of not receiving a request for creating a resource or for modifying a created resource from the target device before the timer expires occurs a threshold amount of times or more.
